(19) United States
(12) Patent Application Publication
(10) Pub. No.: US 2002/0043149 A1
(43) Pub. Date: Apr. 18, 2002

(54) Music teaching aid

(76) Inventor: Stephen Imre Barlay, Pepperell, MA (US)

Correspondence Address: Stephen Imre Barlay, 37 Parkwood Drive, Pepperell, MA, 01463, US

(21) Appl. No.: 09/928,945

(22) Filed: Aug. 13, 2001

Related U.S. Application Data
(60) Provisional application No. 60/226,027, filed on Aug. 18, 2000.

(51) Int. Cl. G09B 15/00

(52) U.S. Cl. 84/470 R

(57) ABSTRACT

A music teaching method teaching the viewer how to incorporate Contrast, Contrasting Transitions, and Flow into their original written songs to learn song structure. This method is intended for teaching songwriters, producers, engineers and anyone else interested in creating or analyzing songs that encompass contrast, contrasting transitions, and or flow. This method is learned by viewing the three song presentations on a computer monitor teaching songwriters how to visually see the structure of songs.

### CROSS-REFERENCE TO RELATED APPLICATIONS

The Write Hit Songs method was first solicited via e-mail to 30 webmasters of major label bands, 27 major label record companies and 25 music publishers on Aug. 8, 2000. On Jan. 2, 2001, the name of our produc was changed from “Write Hit Songs” to “Arrange N Mix.”

Provisional Application

Application No.: 60/226,027

Filing Date: Aug. 18, 2000

### BACKGROUND OF THE INVENTION

In Our Search

There are many musical notation devices found in our search but none of the searched teaching aids are similar to the Arrange N Mix method. There are known music teaching aids that teach music theory, but none that teach song structure by visual means of using a computer monitor with animated images that synchronize with a given song. The Arrange N Mix method is referring to the teaching of contrast, contrasting transitions, flow, and overall song structure utilizing the Motion Elements in a visual environment. There are musical notation devices found in our search, such as application No. 874865 music teaching aid, but none that teach song structure, flow and contrast of music by using visual dots to illustrate flow, contrast, and contrasting transitions within a song structure. There are no known inventions related to the enclosed invention. Prior to this music method, there has been no way to see in a visual sense how music is constructed. Prior to this invention a composer, producer, or engineer would have to learn music theory and spend years writing songs to improve their song structures. This product teaches accelerates learning of song structure with the use of displaying images on a computer monitor for accelerated learning of song structure, contrast, contrasted transitions, and flow within songs.

### BRIEF SUMMARY OF THE INVENTION

The general idea of the claimed invention is the visual movement of dots on a computer screen, Television or any other visual monitor; in which each color-coded visual dot represents each musical instrument or vocal. For example, for vocals (represented by the color Yellow) the Dot would bounce on the Yellow stationary circled rings while bouncing in ⅛^{th} beats moving center, left, center, right, center, left, center, right and so on. The viewer learns Contrast, Contrasting Transitions, and Flow within songs. The Motion Elements only appear when there is profound contrast, contrasting transitions, or flow within the section of the song being heard.

The viewer accelerates learning song structure by using this method. Music theory will teach choice of musical notes to play, while our method does not teach music theory, it teaches song structure. Song structure includes contrast, contrasting transitions, and flow to keep the listeners attention to the song.

### BRIEF DESCRIPTION OF DRAWINGS

Preferred forms of the music teaching aid of the invention will now be illustrated in the accompanying drawings. These forms are described by way of example only and are not intended to limit the scope of the invention in any way.

Drawings

FIG. 1 shows the Introduction screen of the Arrange N Mix CD-ROM. This will auto-run when you place CD-ROM into hard drive of computer.

FIG. 2 shows the Control-Panel in which to choose song presentations or instructions.

FIG. 3 shows the screen for the Arrange N Mix User Instructions. This is how the user learns the product.

FIG. 4 shows the Arrange N Mix screen-shot of song presentation screen user-interface.

FIG. 5 shows the song presentation screen with figures.

FIG. 5A shows the Write Hit Songs logo. Write Hit Songs is our company that produced the “Arrange N Mix” product.

FIG. 5B shows the Motion Elements Color-Scheme Window.

FIG. 5C shows tabs indicating the part of the song currently being heard.

FIG. 5D shows the logo of the band whose song is playing in song-presentation.

FIG. 5E shows the Motion Elements Window.

FIG. 5F shows the Yellow Text Box that gives information about the song being heard.

FIG. 5G shows the Motion Elements Base. The Base is a stationary placeholder for the Dots.

FIG. 5H shows a Dot Motion Element. The Dot bounces on the Bases.

FIG. 6 shows the Motion Elements Collection (Motion Elements).

FIG. 6A shows the Dot Motion Element.

FIG. 6B shows the High-Dot Motion Element.

FIG. 6C shows the Ring Motion Element.

FIG. 6D shows the Base Motion Element.

FIG. 6E shows Step-Dot Motion Element.

FIG. 6F shows the Exploding-Dot Motion Element.

FIG. 7 shows an image of the common triangle pattern used in the Arrange N Mix concept.

FIG. 8 shows a hand-drawn Song Graph.

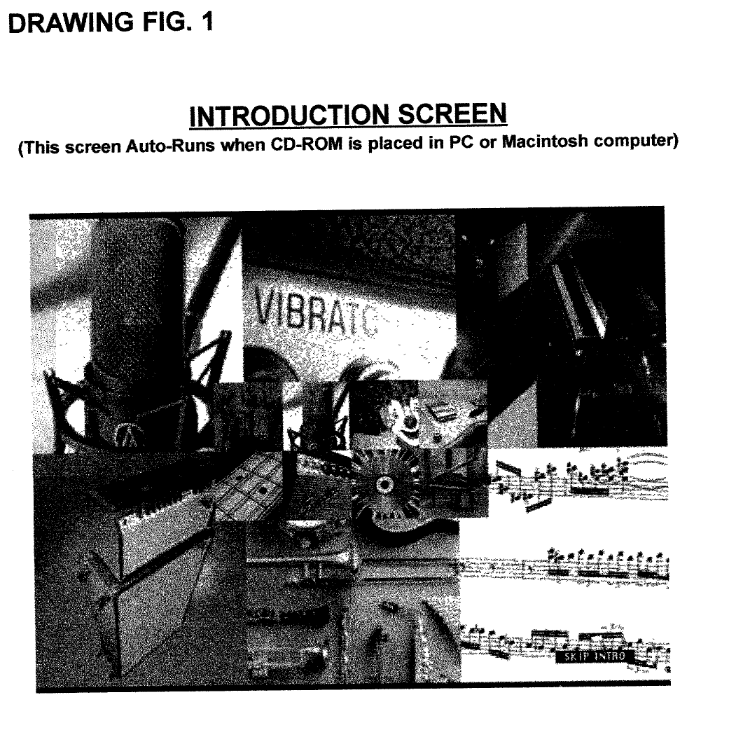

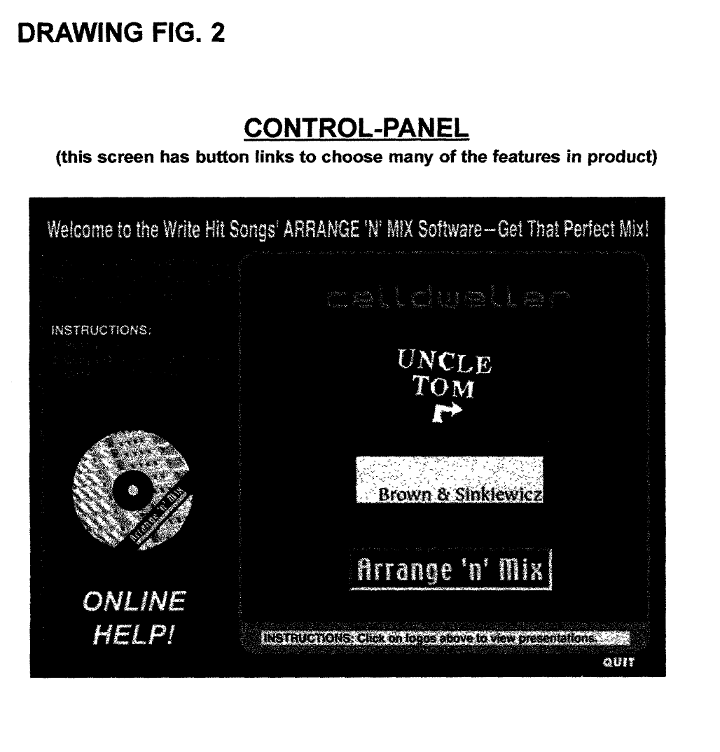

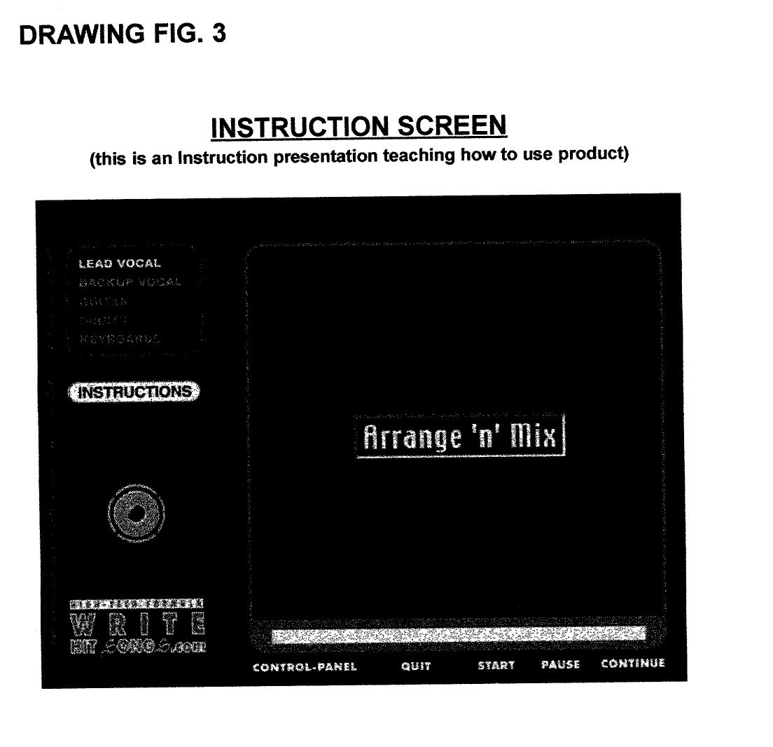

### DETAILED DESCRIPTION OF THE INVENTION

This application enclosed has a provisional application filing date of Aug. 18, 2000. The provisional application No. is 60/226,027.

When referring to songs within this method, we are using straightforward pop/rock songs for our examples. The Arrange ‘N’ Mix song presentations are taught visually and audibly and can be used at any time by implementing the Motion Element method in ones mind while composing songs. This method can be used for any task that incorporates creative listening within music, music and video and, or any other audible art form. You can use this concept with any style of music, but you will first need to learn the concept from a straightforward pop/rock format (3 song-presentations). Then take what you have learned and implement it in any style of music that you choose. This teaching aid includes three songs as examples to show how contrast, contrasting transitions, and flow are utilized within each song.

Works With any Style

Motion Elements work with any style of music, such as pop, mainstream, contemporary, modem-rock, rock, hard rock, metal, thrash, heavy metal, rap, classical, dance, techno, industrial, funk, hip-hop, children's music or any other style or classification of music.

About the Presentation

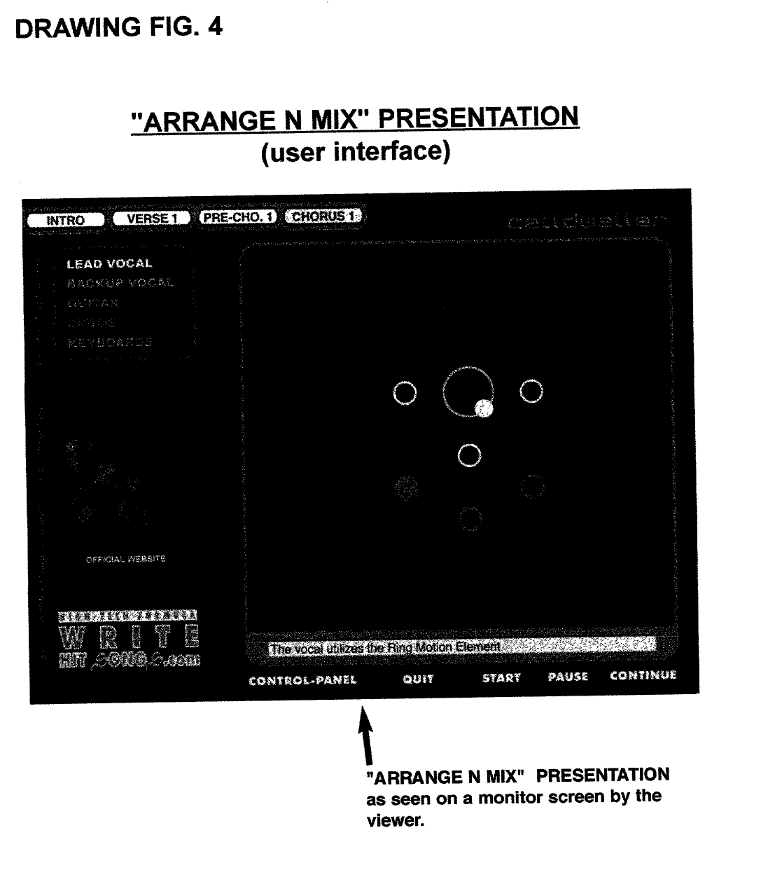

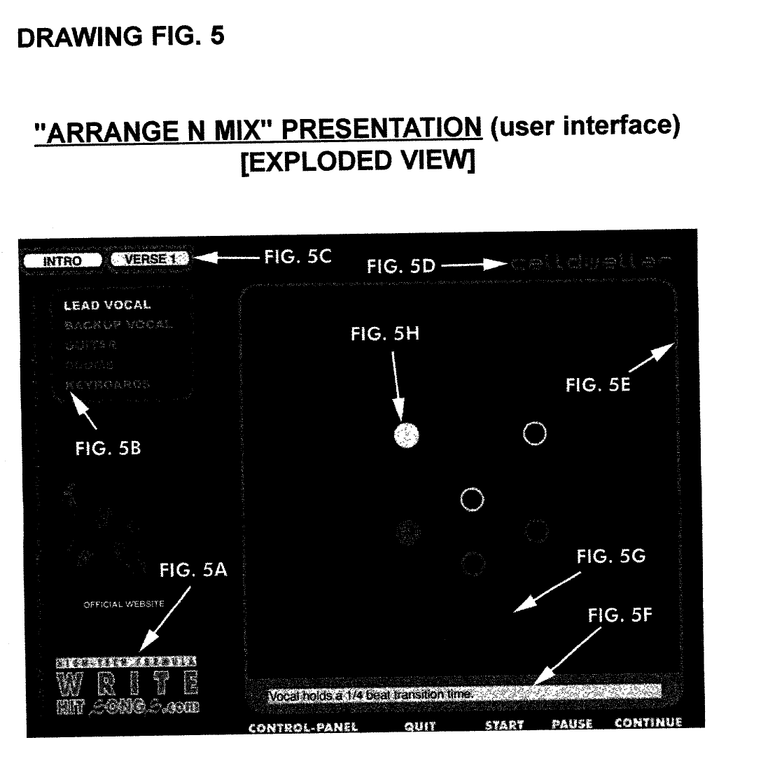

Throughout this document, “Arrange N Mix” FIG. 4. “Arrange N Mix presentation” is the completed visual/audio product that the consumer will use as a teaching aid for learning the Arrange N Mix method. Arrange N Mix presentation FIG. 5 includes Motion Elements, Write Hit Songs' logo FIG. 5A, color scheme FIG. 5B for identifying musical instruments and vocals, and band logo FIG. 5D of which song plays from that musical artist in the Arrange N Mix presentation, section tab FIG. 5C to identify each part of the song (verse, chorus, bridge etc), yellow text box FIG. 5F that shows the viewer “text” relating to the song presentation being viewed.

How it Works

Arrange N Mix music teaching aid is a method of being able to visually see how a song is constructed. In our song-presentations in this product, we only show Motion Elements for instruments or vocals that are Contrasting, Contrasting Transitions, or assist in the Flow of the song. The Structure of a song comprises of contrast, contrasting transitions, and flow. A music teaching aid comprising of visual images displayed on a computer screen while utilizing Macromedia Flash software to display the animated images' color. The Arrange N Mix concept relies heavily on elements such as contrasting transitions, contrast and flow between musical instrument(s) or vocal(s) occurring within an original song, or a previous or present Billboard® 100 charted song. The Arrange N Mix song presentations are how the viewer learns by viewing and listening to the Arrange N Mix presentations simultaneously. Arrange N Mix is a CD-ROM product sold on the Internet at www.writehitsongs.com.

What it Does

The invention relates to a music teaching aid, in particular, a method for learning to identify song structure, which encompasses contrast, contrasting transitions, and flow within songs. Arrange N Mix is taught visually and audibly and can be used at any time by implementing the Motion Element concept in one's mind while composing songs. Arrange N Mix displays visual images for identifying contrast, contrasting transitions, and flow between musical instruments or vocals or sounds occurring within an original song or a previous or present Billboard® 100 charted song. The Arrange N Mix presentation is pre-programmed with three preset songs and animation teaching, contrasting transitions, contrast and flow for each song. Arrange N Mix assists songwriters in analyzing their originally written songs or Billboard® 100 charted songs for flow, structure, contrasting transitions and contrast in musical instrument(s) or vocal(s) and contrasting transitions in musical instrument(s) or vocal(s) or sound(s). Songwriters can analyze originally written songs while composing songs or while listening to the song from a playback device. A playback device could be a computer, stereo, television or any other audio playback system.

What are Motion Elements

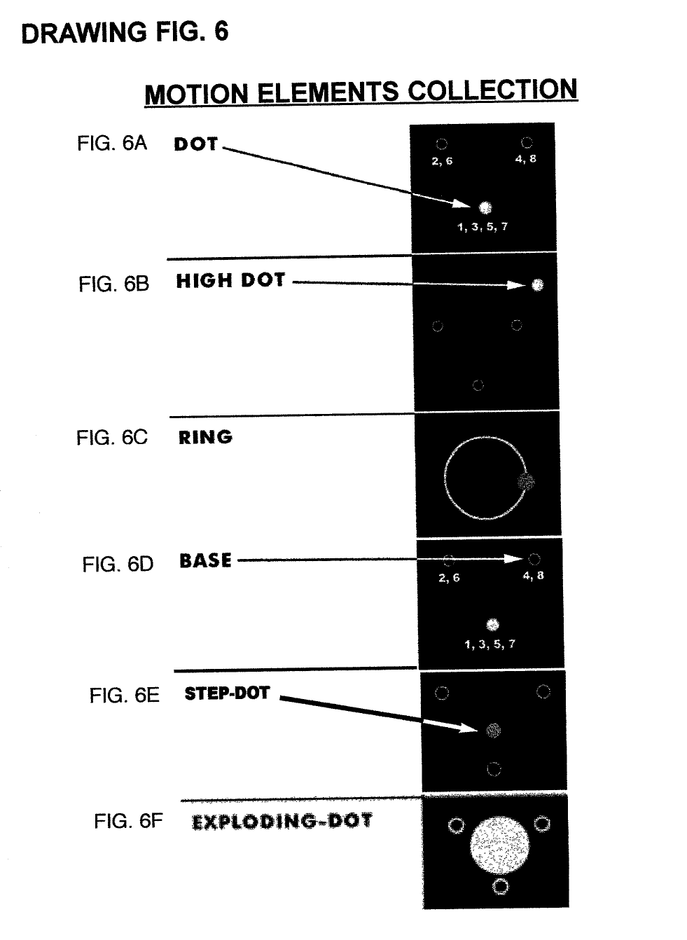

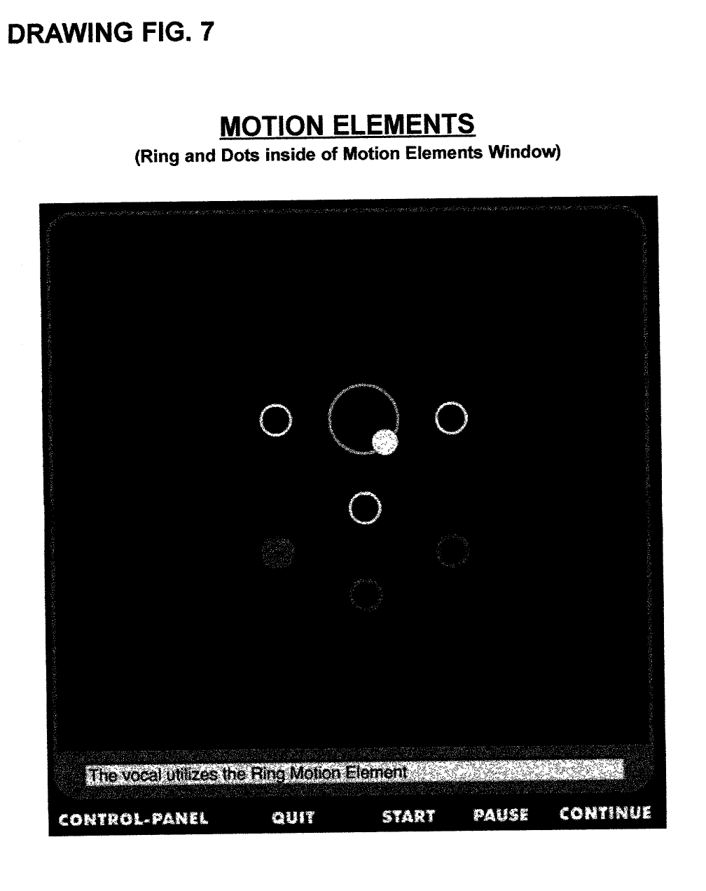

Motion Elements are any visual shape seen by the human eye or visualized in the mind-tangible or non-tangible objects. Motion Elements are the dots or any other image or shape that is hand-drawn or computer generated. In the case of said invention; we have chosen appropriate images FIG. 6 to represent each instrument and vocal. We have created the most logical assortment of shapes within the Motion Elements Collection FIG. 6. Simple shapes are used for the Motion Elements in order not to confuse the viewer. Sporadic use of the Dot Motion Element for vocal melody, help keep the vocal melody melodic and interesting. When Using Motion Elements (High-Dot, Step-Dot and Ring) sparingly throughout the song, you add surprises and keep the listeners attention.

What They Do

The Motion Elements are the graphics as seen within each song presentation window. The Motion Elements are visible in song presentations only when an instrument in the song has surmountable Contrast, Contrasting Transitions, and Flow. You are aiming for consistent Contrast, Contrasting Transitions, and Flow within your songs—learning how to create logical powerful musical arrangements from beginning to end of your song. Motion Elements signal to the person viewing the Arrange ‘N’ Mix presentation, which instrument(s) or vocal(s) are currently contrasted or flowing. Motion Elements are viewable simultaneously identified by their own color in the Motion Elements Window FIG. 5E. Motion Elements represent the flow, structure, contrast and, or transitional movement of each musical instrument or vocal within the Arrange N Mix presentation. Motion Elements synchronize with the music in any given song. Motion Elements FIG. 6 illustrates the bounce pattern on the Motion Elements Bases FIG. 5G in a triangular pattern. The Motion Elements Dot FIG. 5H show the number order in which the Dot image typically pulsates on the Bases. Motion Elements only identify the musical instrument(s) or vocal(s) that are flowing, contrasted transitions and, or contrasted all at once or singularly or used in any combination. Motion Elements signal the person viewing the Arrange N Mix presentations by presenting a Motion Element FIG. 6 that identifies the given musical instrument(s) or vocal(s). A dot is one of the many Motion Elements FIG. 6A. Motion Elements illuminate on the Bases within the Motion Elements Window FIG. 5E. Motion Elements can be visualized in one's mind while composing an original song. Motion Elements can be visualized in one's mind while listening to a pre-recorded song. Motion Elements can be utilized with any musical instrument, voice, vocal and sound either humanly or computer generated. Motion Elements is a concept that can be used both, visually or mentally. Motion Elements are any visual shape visualized in the mind or computer generated. Motion Elements is identified by a colored dot FIG. 6A or any other image from the Motion Elements Collection. Motion Elements are tangible or non-tangible objects and, or shapes. Any that can be seen by the human eye is a Motion Element. A Motion Element could be a woman dancing, colored dot bouncing, monster climbing, foot tapping side to side, ring turning, face shaking, guitar or any other conceivable object. A Motion Element could be an object that can be touched by the human hand, or can be an object that is only seen by the human eye, or an object that is imagined in ones mind. A Motion Element is an image or object imagined in the human mind. Motion Elements are objects or images comprehended either visually and, or mentally.

Why Motion Elements Blink

If there is no contrast or transition within the song, then no Motion Elements will be visible in the Motion Element Window FIG. 5E. Motion Elements only blink or move within the Motion Elements Window when flow, contrast or contrasting transitions are of valued amount. If there is no flow, contrast or contrasting transitions in the music section presented then you will only see Bases FIG. 6D.

When Motion Elements are Used

Motion Elements are not used for all instruments at all times; sometimes there is only one Motion Element for vocals and one for guitar throughout a given song. Motion Elements are used in a song only when it works with the flow, contrasting transitions, structure and contrast of musical instrument(s) or vocal(s) of a given song. Only contrasted or contrasting transitioned musical instruments or vocals will be visible in the Motion Element Window—parts of a song that are intended to grab the listeners' attention. Motion Elements display visual (shapes) in the song presentation when there are Contrasted or Contrasting Transitions within the song—Contrasted rhythm, rhyme, melody, power, and flow. Note that Motion Elements do not need to be visualized throughout the whole song, there can be about 10 seconds without Motion Element movement within one given section of a song (verse, chorus, bridge, etc). Any longer than 10 seconds and the listener's attention will drift from the song. Motion Elements typically remain throughout most hit songs, leaving only small portions without any Motion Elements. The gaps without Motion Elements are a breather for the song. Motion Elements are usually visible throughout the whole song, but sometimes they are not visible in bridges. Some bridges do not impose any groove or contrast and, therefore, those parts of the song do not show Motion Elements within the Motion Elements Window. Some bridges may only have one Motion Element visible; this indicates the breather of the song. You may choose to write a very obscure section for your song, if so, it is highly recommended to at least keep the power and, or the rhythm of the song alive within this section of the song. Most of the songs that do not get posted on the Billboard music charts fail to keep the flow of rhythm throughout the song.

Tapping-technique

We have found that tapping out the beat of the Motion Elements (on your knee) along with the song presentations is the best way to learn the structure of songs. View a song presentation while tapping out (8th beats) for each musical instrument and vocal individually (in its entirety). Simply tap at tempo rate of the song. In most songs, the lead vocal is the most complex of all sounds. View the instructions on the CD-ROM for proper tapping technique. Tap out and count the Motion Elements to song presentations in order to become familiar with the various melody structures. Motion Elements will only identify the musical instruments or vocals that are contrasted, contrasted transitions and, or flowing within a given song.

Dot Motion Element

The Dot Motion Element FIG. 6A is the most widely used for vocal melodies, drums and guitar. Think of the Dot as being a plate of food, while all other Motion Elements being the spices (used sparingly).

When it Illuminates

The Dot illuminates in time with the music. The emphasized or contrasted word(s) of the vocal, is when the Dot will illuminate between the three Bases. There are times when the vocal may emphasize a word but the Dot does not go with it exactly. The Dot is only a rough guideline for a musical instrument or vocal to follow. The Dot typically uses a three-way Base for vocals and drums, and the guitar typically uses a two-way Base. Motion Elements always begin illuminating on the Center Base, the Top-Left Base, and then the Top-Right Base.

How it Bounces

In the song presentations, the Dot will bounce to the top left base emphasizing the lyrical rhyme. If the end of the lyrical line does not rhyme with first line, then the Dot will illuminate to the top right Base. Below shows the illuminating pattern of the Dot. By following the numbers in order of sequence starting with number 1, 2, 3, 4, 5, 6 and so on, you will understand the way in which to visualize Dots for any given song.

Pattern of the Dot

Motion Elements for lead vocals typically use a Dot FIG. 6A and bounce in a triangular pattern FIG. 6D shows the illuminating pattern of the Dot by following the numbers in order of sequence starting with number 1, 2, 3, 4, 5, 6 and on. Motion Elements typically illuminate while keeping the timing of the bounce with the tempo of the music being heard in the Arrange N Mix presentation FIG. 4. When listening to a vocal in Arrange N Mix presentation, the emphasized or contrasted word(s) of the vocal are when the Dot FIG. 5H would illuminate on one of the three Bases FIG. 6D.

Base

The Base is a place keeper for the Dots, to pulsate. The Base indicates where the Dot Motion Element will illuminate within the Motion Elements Window. The Motion Elements bounce on the Bases performing a synchronized dance. The Base Motion Element FIG. 6D is used as a place-keeper for the viewer. The base makes it easier to know where the dot or any other Motion Element will illuminate.

High-dot Motion Element

The High-Dot FIG. 6B is visible when an instrument or vocal plays a high-note in a song (typically before or after the chorus in many songs). The high-note in music adds contrast to the song (contrasting transition). The High-Dot is an extension of the Dot. The Dot, High-Dot, and the Step-Dot, together forms a hook for any given song. The High-Dot and the Ring can sometimes be interchangeable when an instrument or melody falls between the two Motion Elements; the important factor here is whether on not you can visualize the Motion Elements with any given song. The High-Dot does not use a Base, because it is only present for around 9-36 seconds per song. If you use the High-Dot for the majority of a song, the listener would have too much ear candy. If you do not use any High-Dots at all, then the listener will have no ear candy and the song will remain mundane.

Step-dot Motion Element

The Step-Dot FIG. 6E is typically used for backing vocals on the chorus. The Step-up Dot has been found to be used often in the chorus of hit songs and is typically used for the Backup vocals. The Step-Dot (purple color-coded) is a Dot that is located in the middle upper portion of the presentation window. The Step-up Dot appears to be a Dot moving upward in the Motion Elements Window. The Step-down Dot appears to be a Dot moving downward in the Motion Elements Window. Typically you will use the upward moving Step-up Dot, considering that most songs build upward dynamically and in pitch, instead of downward. The Step-Dot does not have a Base because it is typically used only on the choruses. The Step-Dot Motion Element FIG. 6E is used when an musical instrument plays notes that go down or up in pitch. The Step-up or Step-down Dot Motion Element is used when all musical instruments and, or vocals go down or up in pitch.

Exploding-dot Motion Element

The Exploding Step-Dot FIG. 6F is used when there is an abrupt force in a musical instrument or vocals sound. The Exploding Step-Dot moves closer to the viewer by growing in size. Check out the song “Symbiont” (Celidweller); in the chorus there is great use of the Exploding-Dot.

Ring Motion Element

The Ring Motion Element FIG. 6C is by far, the most spectacular element in the Motion Elements Collection—adding extreme amounts of power and contrast to the melody and music of any given song. The Ring Motion Element is visible when there is a flowing musical instrument or vocal. The musical instruments and, or vocals must be flowing (legato passage) to qualify as a Ring. The smooth flow of music is a “legato” passage (a musical term). The Ring is sometimes used for the lead and backing vocals at end of the chorus. The Ring is always a constant flowing Motion Element and always returns to the point in which it started (360-degree turn). The Ring is typically used for around 5 seconds at a time (no more than 10 seconds at a time), 9 to 36 seconds maximum in any given song. If you are looking for that huge wall of vocals or contrast, then incorporate the Ring Motion Element within your songs. Check out the song presentation “Blonde Hair” (Uncle Tom), for a great use of the Ring. Usually the Ring indicates a climax in the song, and is the hook of the song. If you do not have a Ring element in your song, then you should probably include one. The use of the legato passage extensively used in the rock music of the 80s (huge wall of vocals). When the Ring (typically the hook), is used in music of today, it tends to add more of a groove flowing passage to the song. The vocal melody of today's music has strayed from the huge wall-of-vocals effect (multiple vocal overdubs), and tends to be only a few vocal-tracks (not much reverb added). The Ring is a very interesting Motion Element and is mostly used in spurts throughout a given song. If the Ring were visible for the majority of a song, the listener would have too much, ear candy (use sparingly). The Dot, High-Dot and Step-Dot in combination, can form a solid hook for your songs.

Contrast

Arrange N Mix is a songwriting teaching aid that teaches contrast between musical instrument(s) or voice(s) occurring earlier or later or all at the same time within a song. Contrast refers to the musical instrument or vocal the listener focuses attention to most. Contrast will make a musical instrument apparent. Without contrast, the musical instrument(s) or vocal(s) would not be as apparent to the listener as with contrasted. A non-contrasting musical instrument or vocal does not grab the listener's attention as the contrasted musical instrument(s) or vocal(s). By making some musical instruments subtle and others up-front, is how you create contrast within a song. Motion Elements signal the person viewing the Arrange N Mix presentation which instrument(s) or vocal(s) are currently contrasted by displaying those Motion Elements within the Motion Elements Window FIG. 5E. Contrast refers to the musical instrument(s) or vocal(s) the listener focuses attention to most within each section of a song. If there is too many contrasting musical instruments and, or vocals within your song, than there will be too much Contrast within the song and many ears will ache. When not enough contrast within the song, the listener will get bored and tune out. At least one instrument needs to stand out at any given time within song.

Contrasting Transitions

Contrasting Transitions are short sections in-between the verse and pre-chorus, bridge and chorus, etc. Contrasting Transitions usually consists of a few musical instruments or vocals playing—consider it a contrasted break in the song. The Contrasting Transition will grab the listener's attention, and will be visually apparent in the presentations. A Contrasting Transition will look different then what you have previously viewed. For example, the blue dot shooting to the right side of presentation screen at the end of the intro, in the song “Symbiont” (Celidweller), is a Contrasting Transition using the High-Dot Motion Element). Take advantage of these transitions. “Contrasting transitions” refers to a contrasting section of the song. The “contrasting transition” is in between a verse and chorus section of the song, or between a pre-chorus and chorus section, or between a chorus and bridge section, or between any combination that pertains to songwriting. The “contrasting transition” will grab the listener's attention because it prepares the listener for the following song section. Motion Elements signal the person viewing the Arrange N Mix presentation which instrument(s) or vocal(s) are currently contrasting transitions.

Flow

By viewing the Arrange N Mix presentation on a computer monitor, the viewer will learn how to make their music flow from the beginning of song to the end of song. “Flow of all sections” refers to musical instrument(s) or vocal(s) flowing from verse of song to the chorus of a song, or from chorus to bridge of a song, or from bridge to end of song and, or any flow pertinent in songwriting. Flowing refers to the smooth continuation within a given song. Flowing refers to the way a particular musical instrument or vocal fits with other musical instruments or vocals within the song. Flowing refers to the flow from a verse section into a chorus section, a chorus section into a bridge section or any other combination pertinent in songwriting. Flow is typically a smooth transition from one section of the song to another, unlike the Contrasting Transition. Flow refers to a verse section flowing into a chorus section, a chorus section into a bridge section, or any other transient combination pertinent to songwriting. View the song presentations and see how smoothly each part flows into the next. For example, once a verse goes into a chorus, the Motion Elements change; meaning the sound has changed. Many beginning songwriters tend to write song transitions that do not flow from one part to another. For example, the end of the verse is cut-off and the chorus is, so to speak, glued on as the next part of the song (like two separate songs). A Flowing Transition is visible within the song presentations—no drastic changes of the song's feel.

Structure

“Structure of all sections” refers to analyzing how all the song sections, parts, musical instruments, vocals and sounds fit together to make a given song. Structure teaches the songwriter how the whole of all musical instruments and vocals work together to make a song more enticing to the human ear. The viewer learns structure by viewing the Arrange N Mix presentation until the method is comprehended. Structure is the exploded view of the song, including the Flow, Contrast, and Contrasting Transitions of the song. Structure refers to how sections, parts, musical instruments, vocals and sounds fit together to make a completed song. Learn how all the musical instruments and vocals work together to make a song more enticing to the human ear. Look at how smoothly the Motion Elements move around within any of the 3 preset song presentations—this is a sign that these are easily digestible songs for radio airplay and chart status. Learn structure by viewing the Arrange ‘N’ Mix presentations repeatedly until you strongly understand how great songs are structured. While viewing, pay close attention to how certain musical instruments or vocals stand out within the presentation.

Color Scheme

The Motion Elements color-scheme window is located in the top left corner of the Arrange ‘N’ Mix presentation screen; each musical instrument or vocal identified by its own color. Motion Elements Color-Scheme FIG. 5B is what Arrange N Mix presentation uses to identify each musical instrument or vocal or orchestra or sound within the Motion Elements Window FIG. 5E. The images displayed use a color-coding system representing a unique color for each musical instrument and voice. For example, for vocals (represented by the color Yellow) the dot would bounce on the Yellow stationary circles FIG. 5G while bouncing in 18^{th} beats moving on the yellow circled rings called Bases (center, left, center, right, center, left, center, right and so on). Each Dot or Motion Element is color-coded so that the viewer can look up in the color scheme window FIG. 5B and see which instrument represents which color.

“Motion Elements color scheme” for musical instruments and vocals and sounds:

Lead vocal or human larynx uses a yellow colored Motion Element.

Backup or harmony vocal uses a purple colored Motion Element.

Guitar uses a dark blue colored Motion Element.

Drums or drums and bass guitar uses a red colored Motion Element.

Bass guitar uses a red or white colored Motion Element depending on song.

Electronic Keyboards or Piano uses a Green Colored MOTION Element.

Motion Elements color scheme as in the Arrange N Mix presentation FIG. 4 shows the colors that represent each instrument in the Arrange N Mix presentation. Motion Elements color scheme uses colors to identify each musical instrument or vocal within the song. The Motion Elements color-scheme FIG. 5B for any given song can be found in Arrange N Mix presentation top left window of computer monitor or viewable device. Motion Element colors is used to identify each musical instrument or vocal within a given song.

Yellow Text Box

The Arrange N Mix presentations have a yellow text box FIG. 5F on the bottom of the Motion Elements Window. The yellow colored text box will automatically show the viewer text messages referring to the part of the song being viewed and heard. The yellow colored text box is integrated into the Arrange N Mix presentations in order to teach the viewer about what is happening in the song presentation. The Yellow Text Box displays text information in order to teach the use of Contrast, Contrasting Transitions, Flowing Transitions, and Structure within each song presentation. The Arrange ‘N’ Mix presentations have a yellow text box on the bottom of the Motion Elements Window. The Yellow Text Box is integrated into the Arrange ‘N’ Mix presentation in order to guide the viewer as they try to make sense of all the Motion Elements moving within the presentation window.

Interactivity

Arrange N Mix encompasses interactive presentations with the song-part tabs which are clickible FIG. 5C and indicate when a section of the song changes (i.e. ver to chorus). The Control-Panel, Quite, Start, Pause, and Continue buttons on the bottom of the Motion Elements Window FIG. 5E are used to control the user-interface.

Write and Then Test Song

Write a song and then test it by visualizing the Motion Elements. Do not spend time writing a whole song and then testing it, test the song after you complete each part (verse, chorus, bridge, etc.) Use this method while listening to your song as it plays from a cassette recorder, or other playback device. Use this concept by visualizing Motion Elements in your mind, in order to check your songs for Contrast, Contrasting Transitions, Flowing Transitions, and Structure. Write songs while simultaneously visualizing the Motion Elements. When writing while visualizing the Motion Elements, you should be mainly concerned about the structure of the melody (everything else will fall into place).

No Drum Fills

Drum fills are not visible with Motion Elements, because the actual playing of an instrument is not what is taught with this method. This method teaches how a song is to be structured, but cannot tell what to play, or what to sing.

Song Graphs

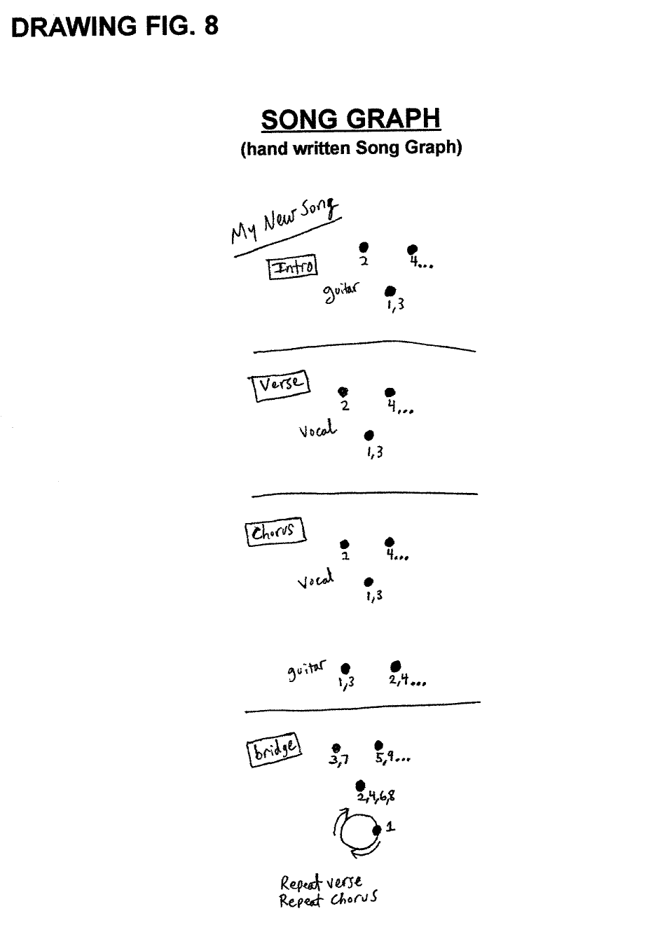

Tap any song of choice, while drawing a graph FIG. 8, you can then study the graph later. You will find that melodies are the toughest to analyze, mainly because the melody is free form over the music. We recommend that you tap out the melody of any given song while viewing any of the 3 song presentations and see if you can follow the tapping structure. Some melodies take hours to figure out; draw a graph. You will find that drawing graphs is not an easy task because the more melodic the melody, the more difficult to decipher.

The music typically does not vary much regarding the tapping out the structure. While you are viewing the song presentations, you will notice that the drums and guitar are not the focal point for the entire song-there are breaks where these instruments are subtle. The lead vocal is often the focal point of the song.

Write out hand-drawn graphs FIG. 8 of songs from your favorite bands. After analyzing The Beatles' music, we have found that the timing of each song had much to do with the melodic content. They use many short structures that lead to melodic sections of the song. Their melodies are very difficult to write out in graph-form because of the complexity of their melodies. The Beatles “Eleanor Rigby” is a simple 4-beat structure. “Mean Mr. Mustard” and “She Said, She Said” have extremely sporadic melody structures. Picture in your mind, the Motion Elements that fit each song part you are writing. Write down the elements in a hand-drawn graph so that you will have a clear view in front of you of where you are within the song and where you are heading. Write out each section in graph form as you mix your song, or write out the whole song graph before writing a song.

Write Graph then Mix Song

Write out a hand-drawn graph and then mix a song to the graph. When drawing a graph, you should be mainly concerned about the structure of the melody. The melody is by far the most important when determining a hit song. Listen to the song from a playback device and visualize which Motion Elements are currently being utilized and which ones you could implement. You can use a Motion Element, such as the Ring, and mix your music to the Motion Elements. To mix a section to a Motion Element, you first need to choose a Motion Element and then mix a part that coincides with the Motion Element that you chose.

The following text describes the three song presentations, pointing out the most vital information regarding contrast, contrasting transitions, and flow.

Song Presentation 1—Celldweller “Symbiont”

Intro

Guitar and drums hold the power.

Verse Vocal

¼ beat transition that holds the vocal. The quatrain rhyme structure is used, and although is quite simple, it is the most used for verse melody phrasings.

Pre-chorus

The lead vocal holds itself with it being the focal point and a very interesting melody structure. The reason no other Motion Elements are illuminated is they are not the dominant focus here at this time. The lead vocal structure, melody, rhyme scheme, and dynamics all assist in making the vocal the most prominent part in this section of the song (also notice how this section utilizes the High-Dot).

Chorus

The lead vocal explodes, making it the most dominant in this section. The exploding vocal in this part is the Exploding-Dot (it steps inward). The vocal melody at end of the chorus flows perfectly with the Ring Motion Element.

Bridge

The keyboard is the focus point here, and changes the feel of the song. The drums and vocals are dynamically in the background, and therefore, do not qualify as dominant instruments. As you see in the song presentation, the drums and vocal eventually build dynamically and become the prominent parts.

Backup Vocals

Notice the backup vocals making step movements by using the Step-Dot.

Overall

This song uses the Dot, and incorporates the High-Dot, Ring, and Step-Dot sprinkled throughout the song.

Song Presentation 2—Uncle Tom “Blonde Hair”

Intro

Song begins with the snare drum exploding. Then the guitar and drums hold the power.

Verse

The lead vocal has a unique structure. Count the bars 2, 2, 4, and 4, simply by tapping out the tempo as presentation plays.

Chorus

The backup vocals use the Step-Dot and move in an upward stepwise movement.

End of Chorus

The backup vocals use the Ring Motion Element. The Ring typically rotates once in a 360-degree turn (clockwise), but this song uses a Ring with a double rotation. In fact, the double Ring hooks the listener more than one rotation of the Ring.

Bridge

This vocal takes a break from all the hooks of the rest of the song and goes into a repetitive melody. Sections such as this are great when you want to leave the listener wanting more of the hook that was previously present.

End of the Song

The song ends with a very prominent sustained guitar. Sustained guitars are common in many songs, but by not using sustained guitars anywhere else within the song, it makes this part stand out.

Overall

This song uses the Dot, and incorporates the High-Dot, Step-Dot and the double Ring sprinkled throughout the song.

Song Presentation 3—Brown & Sinkiewicz “Something Wicked”

Intro

Starts with the guitar setting the mood for the song.

Verse

The lead vocal has a visual structure of 2, 2, 4, and 8 beats per bar. Analyze the presentation and visually see how the melody is structured.

Chorus

Uses High-Dots on lead vocal and backup vocals-working together and forming a melody accompanied by an interesting harmony.

End of Chorus

The lead vocal and backup vocal both work in unison to complete the end of the chorus.

Bridge

This vocal (quatrain rhyme structure), takes a break from all the hooks of the rest of the song and goes into a repetitive melody. Sections such as this are great when you want to leave the listener wanting more of the hook that was previously present.

Chorus Variation

This is a vocal-only section (a cappella) that incorporates harmonies and is a great breather for the song.

Overall

This song uses the Dot, and incorporates the High-Dot and Step-Dot sprinkled throughout the song. This song does not need the Ring because it uses the High-Dot and Step-Dot in many sections. Overall, if you are in need to learn harmony, this is the perfect song!

Macromedia Shockwave Flash Software

Arrange N Mix uses Macromedia Flash Player software to view the Shockwave Flash files. Computer animation is used to teach the Arrange N Mix songwriting method. We disclose that we are not claiming ownership of the Macromedia Flash animation software, but the songwriting method illustrated when viewing the song presentations. We are not claiming ownership of the Macromedia Flash software but are using this software to demonstrate this music teaching method. The computerized animation was made possible by using Macromedia Flash computer software. The visuals and audio of playback of the presentation as a teaching aid was made possible by the Flash Player computer software installed on a Windows® or Macintosh operating systems. The Arrange N Mix song presentations are generated by using licensed Macromedia Flash software to illustrate the Motion Element concept. We disclose that we are not claiming ownership of the Macromedia Flash animation software, but the songwriting method illustrated when viewing the song presentations.

1. What I claim as my invention is a visual method of learning song structure by using moving images on a computer monitor or any other visual device to teach contrast, contrasting transitions, and flow.

2. A music teaching aid according to claim 1 visually displays Motion Elements that represent when a song embodies contrast, contrasting transitions and flow within any given song by Motion Elements pulsating on Bases as viewed on a computer monitor screen or visual device.

3. A music teaching aid according to claim 1 shows Motion Elements in the Motion Elements Window only when a musical instrument, vocal, or sound is contrasted, a contrasting transition, or is flowing.

4. A music teaching aid according to claim 1 comprising of contrast in the introduction, verse, pre-chorus, bridge, solo section, and any other song section pertinent to songs; contrasting transitions between sections; flow throughout the song using many instruments, voice, and sounds. A music teaching aid according to claim 1 comprising of Motion Elements that are visually displayed on any visual monitor and may also be a tangible or a non tangible object.
```
Return-Path: <.arena.light@home.com>
Received: from rly-zc05.mx.aol.com (rly-zc05.mail.aol.com
[172.31.33.5]) by air-zc03.mail.aol.com (v75_b3.11) with ESMTP;
Thu, 10 Aug 2000 11:47:28 -0400
Received: from mail.rdc1.ne.home.com (ha1.rdc1.ne.home.com
[24.2.4.66]) by rly-zc05.mx.aol.com (v75_b3.9) with ESMTP;
Thu, 10 Aug 2000 11:44:25 -0400
Received: from ci488616a ([24.2.114.242]) by mail.rdc1.ne.home.com
  (InterMail vM.4.01.03.00 201-229-121) with SMTP
  id <20000810154423.CGTG17075.mail.rdc1.ne.home.com@ci488616a>
  for <.WEBMAN344@aol.com>; Thu, 10 Aug 2000 08:44:23 -0700
Message-ID: <002001c002e1$e7bb8fe0$f2720218@nash1.tn.home.com>
From: “Danny Arena/Sara Light” <.arena.light@home.com>
To: <.WEBMAN344@aol.com>
References: <.c.9265a4a.26c40238@aol.com>
Subject: Re: ADVERTISING
Date: Thu, 10 Aug 2000 10:44:42 -0500
MIME-Version: 1.0
Content-Type: text/plain;
  charset=“iso-8859-1”
Content-Transfer-Encoding: 7bit
X-Priority: 3
```
```
Return-Path: <.arena.light@home.com>
Received: from rly-zd03.mx.aol.com (rly-zd03.mail.aol.com
[172.31.33.227]) by air-zd02.mail.aol.com (v75_b3.11) with ESMTP;
Sat, 12 Aug 2000 10:43:12 -0400
Received: from mail.rdc2.pa.home.com (ha1.rdc2.pa.home.com
[24.12.106.194]) by rly-zd03.mx.aol.com (v75_b3.9) with ESMTP;
Sat, 12 Aug 2000 10:43:01 -0400
Received: from ci488616a ([24.2.114.242]) by mail.rdc2.pa.home.com
  (InterMail vM.4.01.03.00 201-229-121) with SMTP
  id <20000812144301.GKSJ22332.mail.rdc2.pa.home.com@ci488616a>
  for <.WEBMAN344@aol.com>; Sat, 12 Aug 2000 07:43:01 -0700
Message-ID: <000501c0046b$a6fbb760$f2720218@nash1.tn.home.com>
From: “Danny Arena/Sara Light” <arena.light@home.com>
To: <.WEBMAN344@aol.com>
References: <7b.815a393.26c430cc@aol.com>
Subject: Re: ADVERTISING
Date: Sat, 12 Aug 2000 09:43:16 -0500
MIME-Version: 1.0
Content-Type: text/plain;
  charset=“iso-8859-1”
Content-Transfer-Encoding: 7bit
X-Priority: 3
X-MSMail-Priority: Normal
X-Mailer: Microsoft Outlook Express 5.50.4133.2400
X-MimeOLE: Produced By Microsoft MimeOLE V5.50.4133.2400
```
Return-Path: <.arena.light@home.com>
Received: from rly-zd03.mx.aol.com (rly-zd03.mail.aol.com
[172.31.33.227]) by air-zd02.mail.aol.com (v75_b3.11) with ESMTP;
Sat, 12 Aug 2000 10:43:12 -0400
Received: from mail.rdc2.pa.home.com (ha1.rdc2.pa.home.com
[24.12.106.194]) by rly-zd03.mx.aol.com (v75_b3.9) with ESMTP;
Sat, 12 Aug 2000 10:43:01 -0400
Received: from ci488616a ([24.2.114.242]) by mail.rdc2.pa.home.com
(InterMail vM.4.01.03.00 201-229-121) with SMTP
id <20000812144301.GKSJ22332.mail.rdc2.pa.home.com@ci488616a>
for <.WEBMAN344@aol.com>; Sat, 12 Aug 2000 07:43:01 -0700
Message-ID: <000501c0046b$a6fbb760$f2720218@nash1.tn.home.com>
From: “Danny Arena/Sara Light” <.arena.light@home.com>
To: <.WEBMAN344@aol.com>
References: <7b.815a393.26c430cc@aol.com>
Subject: Re: ADVERTISING
Date: Sat, 12 Aug 2000 09:43:16 -0500
MIME-Version: 1.0
Content-Type: text/plain;
charset=“iso-8859-1”
Content-Transfer-Encoding: 7bit
X-Priority: 3
X-MSMail-Priority: Normal
X-Mailer: Microsoft Outlook Express 5.50.4133.2400
X-MimeOLE: Produced By Microsoft MimeOLE V5.50.4133.2400
